(19) United States
(12) Patent Application Publication
(10) Pub. No.: US 2012/0052712 A1
(43) Pub. Date: Mar. 1, 2012

(54) PLUG CONNECTOR HAVING IMPROVED RELEASING MECHANISM AND A CONNECTOR ASSEMBLY HAVING THE SAME

(75) Inventors: CHIEN-CHIUNG WANG, New Taipei (TW); QING-MAN ZHU, Kunshan (CN); XUE-LIANG ZHANG, Kunshan (CN)

(73) Assignee: HON HAI PRECISION INDUSTRY CO., LTD., New Taipei (TW)

(21) Appl. No.: 13/217,645

(22) Filed: Aug. 25, 2011

(30) Foreign Application Priority Data
Sep. 1, 2010 (CN) 201020513190.4

(51) Int. Cl. H01R 13/627

(52) U.S. Cl. 439/352

(57) ABSTRACT

A connector assembly (100) includes a receptacle (1) having a latching tab (10) defining a latching hole (101) and a plug connector (3). The plug connector includes a housing (31) having a latching protrusion (313) for latching with the latching hole of the receptacle, and a releasing mechanism (36) including a releasing portion (368) formed in front of the latching protrusion and having a forwardly downwardly inclining releasing face (3681), an actuator (364), and an operator (361) formed with a first beam (3612). The first beam is movable, together with the actuator, from a latched position to a released position along the releasing face of the releasing portion to expel the latching tab outwardly to release the latching protrusion from the latching hole of the receptacle.

### BACKGROUND OF THE INVENTION

1. Field of the Invention

The present invention relates to a plug connector and a connector assembly, and more particularly to a SFP (Small Form-Factor Pluggable) plug connector adapted for releasably latching with a receptacle and a connector assembly having the same.

2. Description of Related Art

U.S. Pat. No. 6,746,158 issued to Merrick on June 8, 2004 discloses an SFP transceiver connector for mating with a receptacle having a latching tab defining a latching hole. The transceiver connector comprises a housing having a latching protrusion for engaging with the latching hole, and a releasing mechanism assembled to the housing. The releasing mechanism includes an actuator, a lever assembled at one end of the actuator, and a pair of releasing portions formed at another end of the actuator. The lever actuates the releasing portions to move from a latched position to a released position, to expel the latching tab to thereby release the latching protrusion from the latching hole.

The releasing member may be designed to take a more simple releasing movement.

Hence, a plug connector having an improved releasing mechanism and a connector assembly having the same is desired.

### SUMMARY OF THE INVENTION

Accordingly, an object of the present invention is to provide a plug connector and a connector assembly having the same, the plug connector including a releasing mechanism having a releasing portion and a releasing beam climbing along the releasing portion to take a simple releasing operation.

In order to achieve the object set forth, a connector assembly includes a receptacle having a latching tab defining a latching hole and a plug connector. The plug connector includes a housing having a latching protrusion for latching with the latching hole of the receptacle, and a releasing mechanism including a releasing portion formed in front of the latching protrusion and having a forwardly downwardly inclining releasing face, an actuator, and an operator formed with a first beam. The first beam is movable, together with the actuator, from a latched position to a released position along the releasing face of the releasing portion to expel the latching tab outwardly to release the latching protrusion from the latching hole of the receptacle.

The releasing mechanism includes a releasing portion formed on the housing, and a first beam on the operator to climb along the releasing portion to take a simple releasing movement.

Other objects, advantages and novel features of the invention will become more apparent from the following detailed description when taken in conjunction with the accompanying drawings.

### BRIEF DESCRIPTION OF THE DRAWINGS

FIG. 1 is an assembled perspective view showing a connector assembly in accordance with the present invention;

FIG. 2 is an assembled perspective view showing the plug connector as shown in FIG. 1;

FIG. 3 is a partially exploded perspective view showing the plug connector;

FIG. 4 is another partially exploded perspective view showing the plug connector;

FIG. 5 is an exploded perspective view showing the plug connector;

FIG. 6 is a cross-sectional view of the plug and a receptacle in a latched position, taken along line 6-6 of FIG. 1;

FIG. 7 is an enlarged view showing the engagement between the latching protrusion, the releasing mechanism and the latching tab, when the releasing mechanism is situated in a latched position; and

FIG. 8 is a view similar to FIG, 6, when the releasing mechanism is situated in a released position.

### DETAILED DESCRIPTION OF THE PREFERRED EMBODIMENT

Reference will now be made in detail to the preferred embodiment of the present invention.

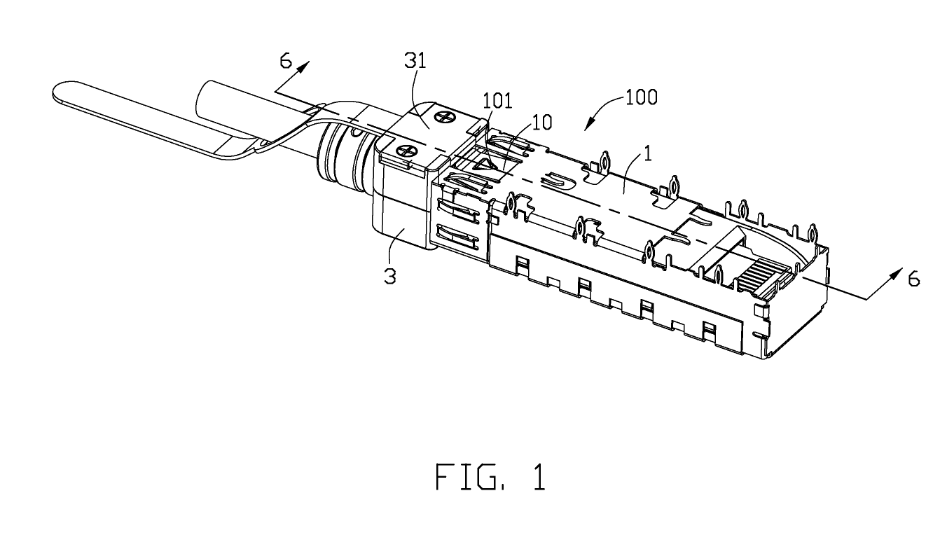

Referring to FIG. 1, a connector assembly 100 in accordance with the present invention includes a receptacle 1 having a latching tab 10 defining a latching hole 101, and a plug connector 3 inserted in the receptacle 1.

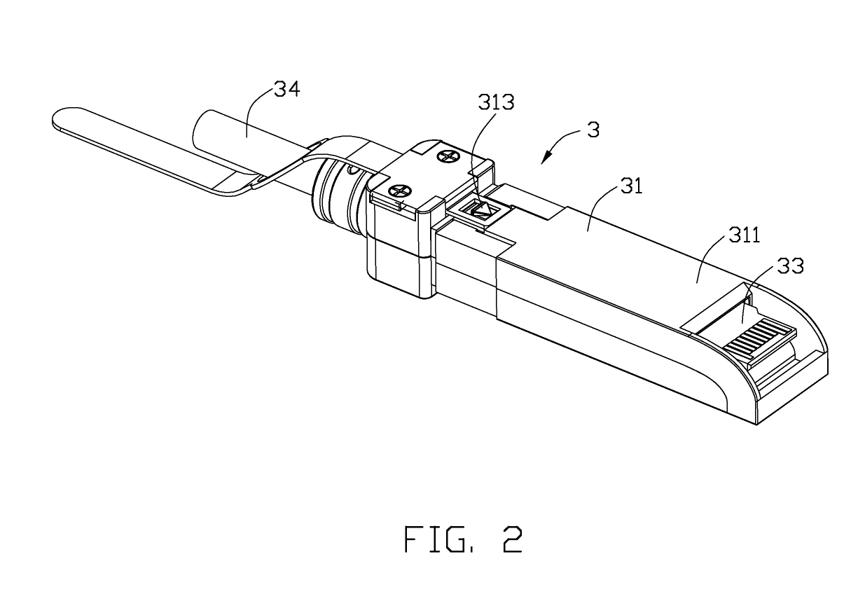

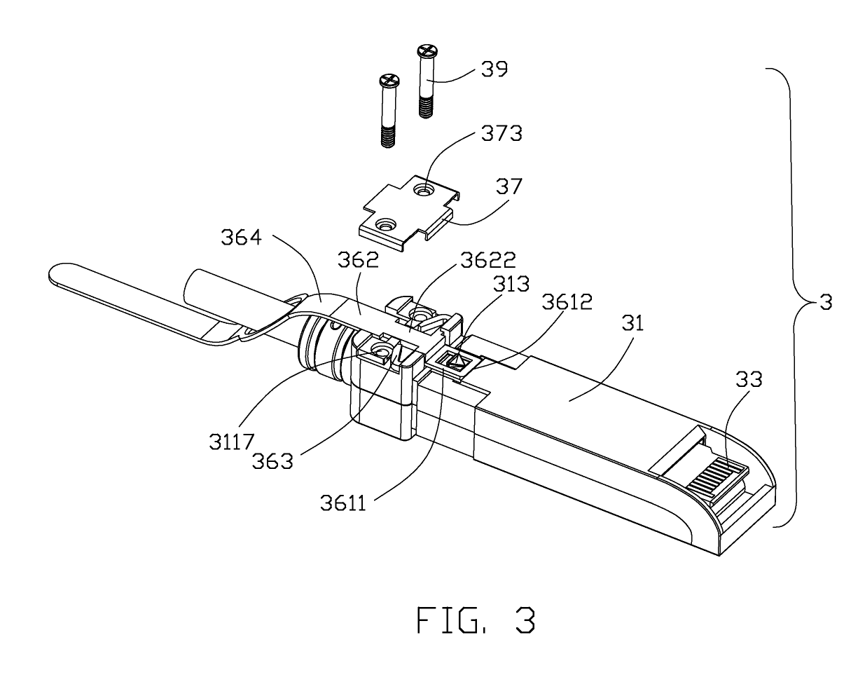

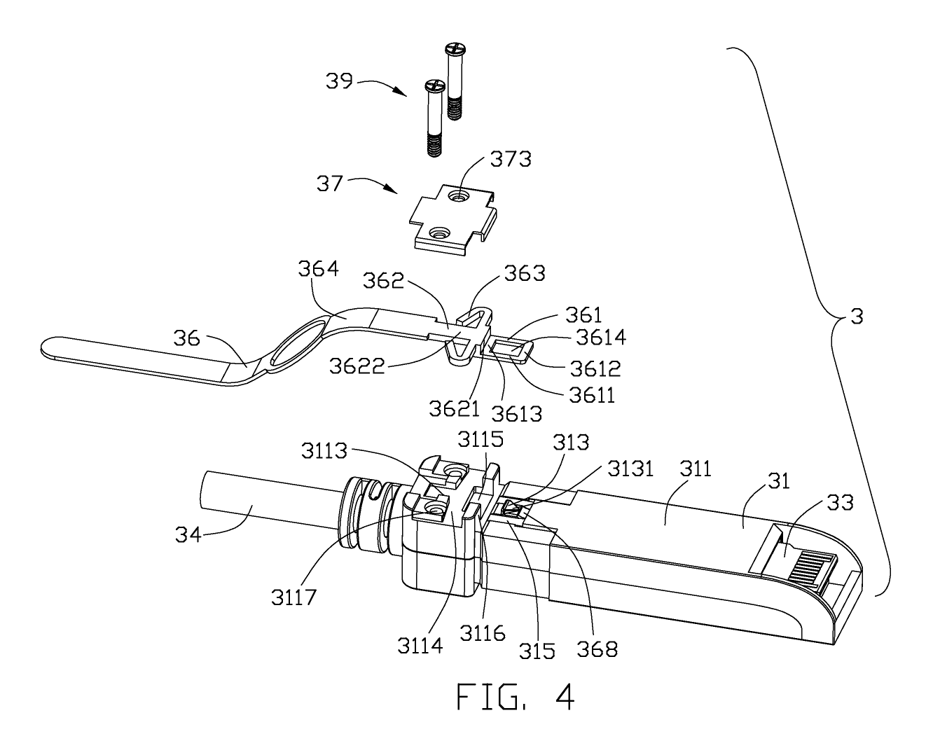

Referring to FIGS. 2 to 4, the plug connector 3 comprises a housing 31 insertion of at least one board 33 connected with the cable 34 via a connecting portion 35, a shielding plate 37 attached to the housing 31, a releasing mechanism 36 assembled to the housing 31, and a pair of screws 39.

The housing 31 comprises a bottom face 311. The housing 31 includes a latching protrusion 313 projecting from the bottom face 311, a pair of concave recesses 315 defined at opposite sides of the latching protrusion 313. The latching protrusion 313 has a latching face 3131 inclining forwardly and downwardly. The bottom face 311 of the housing 31 includes a pair of supporting portions 3116 extending downwardly, an indentation 3115 defined between the pair of supporting portions 3116, and a pair of inserting holes 3117 extending along an up-to-bottom direction. The bottom face 311 further defines a receiving space including a securing recess 3113 extending longitudinally along a mating direction, and a receiving recess 3114 extending transversely along a transverse direction perpendicular to the mating direction.

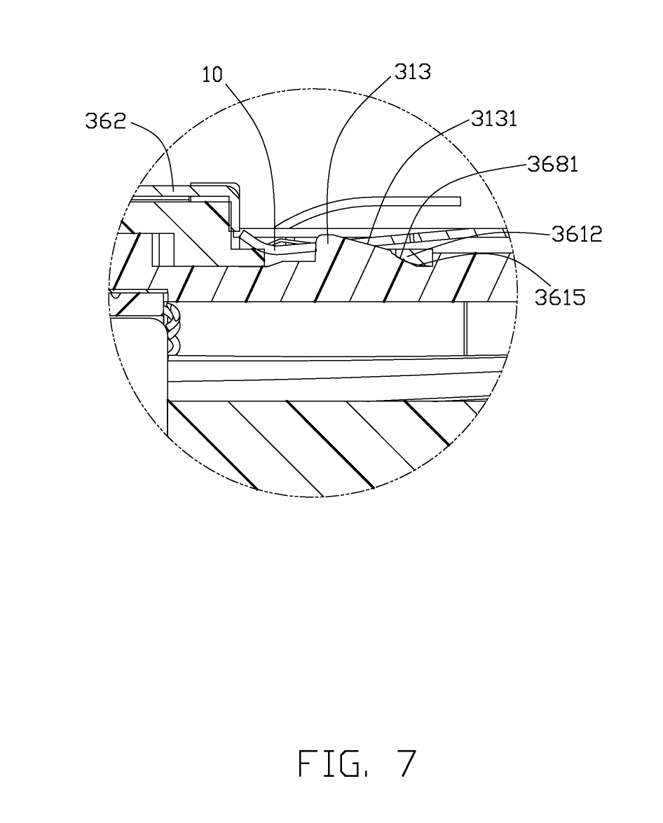

The releasing mechanism 36 comprises an actuator 364, a deformable portion 362 formed in front of the actuator 364, and an operator 361 formed in front of the deformation portion 362. The operator 361 includes a first beam 3612, a second beam 3613, a pair of third beams 3611, and an opening 3614 defined therebetween. The deformable portion 362 includes a body portion 3622, a pair of resilient portions 363 projecting from opposite sides of the body portion 3622, and a stepped portion 3621 between the operator 361 and the resilient portions 363. Each resilient portion 363 is formed into substantially compressible U-shape. The releasing mechanism 36 further includes a releasing portion 368 formed at the bottom face 311 of the housing 31 and situated in front of the latching protrusion 313. In conjunction with FIG. 7, the releasing portion 368 has a forwardly downwardly inclining releasing face 3681 extending continuously from the latching face 3131 of the latching protrusion 313. The first beam 3612 of the operator 361 is formed with an obliquely extending first face 3615 cooperating with the releasing face 3681 of the releasing protrusion 368.

The shielding plate 37 defines a pair of through holes 373.

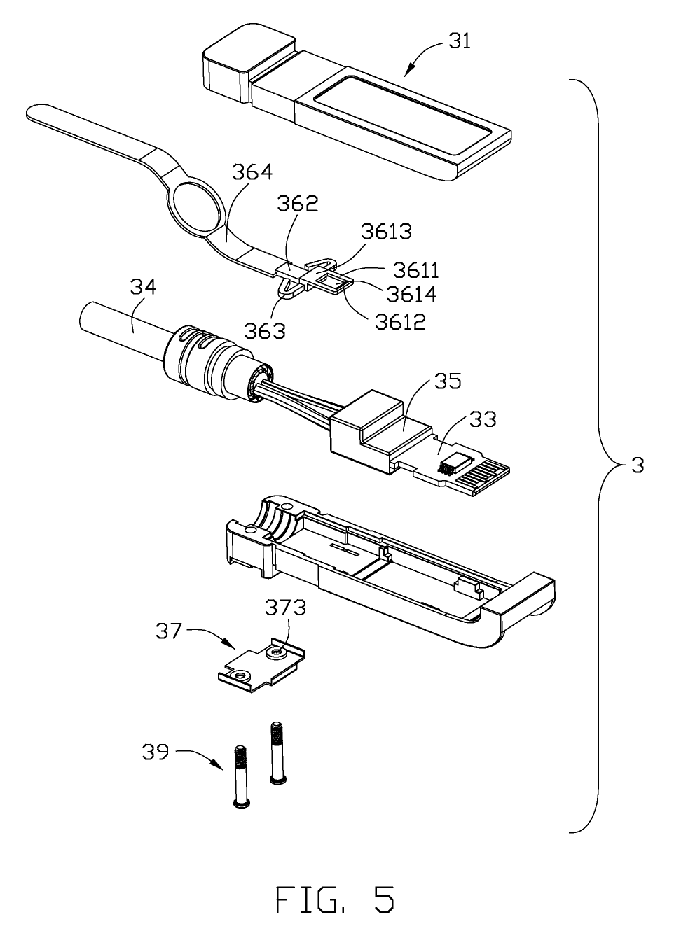

Referring to FIGS. 1-6, in assembling of the plug connector 3, the board 33 is received in the housing 31. The releasing mechanism 36 is attached to the housing 31, with the latching protrusion 313 plunged in the opening 3614, the stepped portion 3621 situated in the indentation 3115, the body portion 3622 secured in the securing recess 3113, the pair of resilient portions 363 compressible in the receiving recess 3114, and the pair of supporting portions 3116 abutted against by the pair of resilient portions 363. The shielding plate 37 is attached to the bottom face 311 of the housing 31, with the pair of screws 39 inserting through the though holes 373 of the shielding plate 37 and the inserting holes 3117 of the housing 31 to secure the shielding plate 37 onto the housing 31.

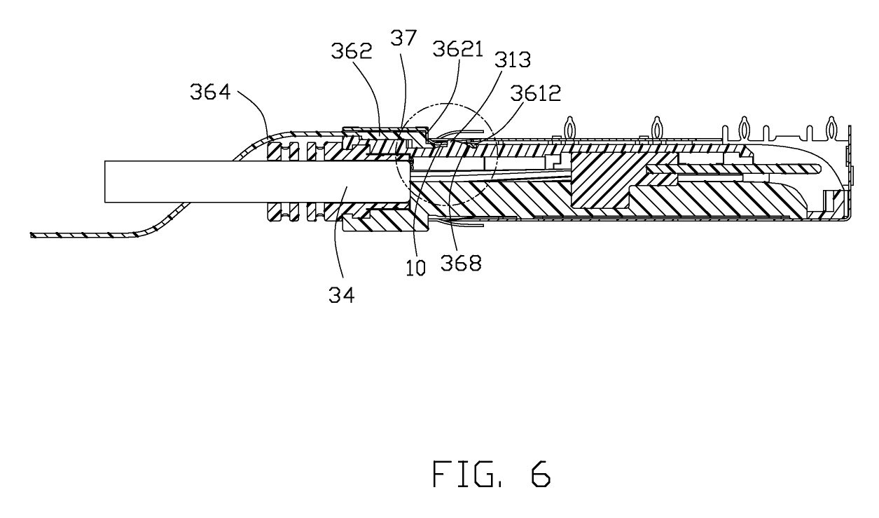

In conjunction with FIGS. 6-7, in a latched position, the latching protrusion 313 is plunged in the opening 3614 of the releasing mechanism 3 and engaged with the latching hole 101 of the latching tab 10 of the receptacle 1. The first beam 3612 of the operator 361 is situated in front of the releasing portion 368.

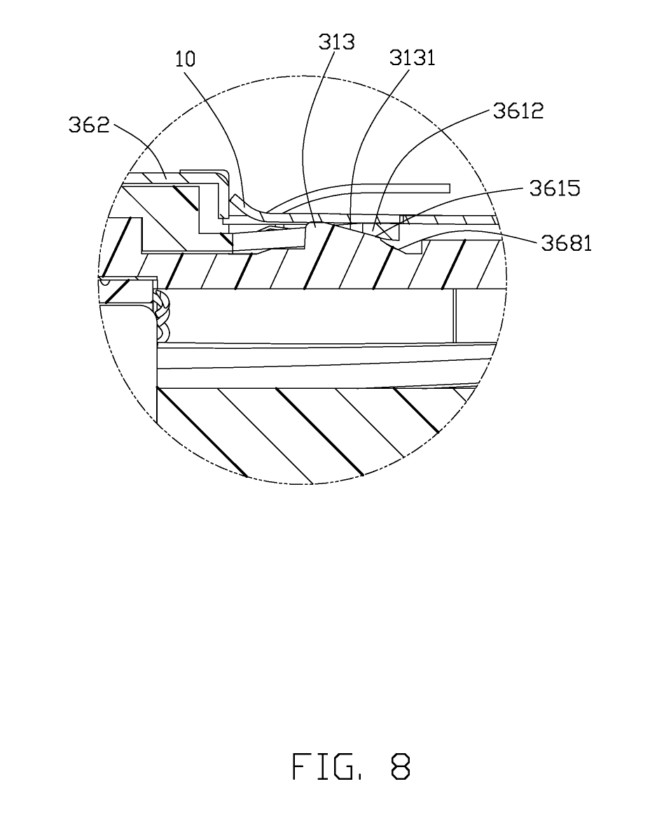

In extraction of the plug connector 3 from the receptacle 1, in conjunction with FIG. 8, when the actuator 364 is pulled rearwardly, the first face 3615 of the first beam 3612 of the operator 361 climbs along the releasing face 3681 of the releasing portion 368 to expel the latching tab 10 outwardly to release the latching protrusion 313 from the latching hole 101 of the receptacle 1. The releasing mechanism 36 is disposed in a released position.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A plug connector adapted for inserting into a receptacle having a latching tab defining a latching hole, comprising:
a housing having a latching protrusion for latching with the latching hole of the receptacle; and
a releasing mechanism comprising a releasing portion formed in front of the latching protrusion and having a forwardly downwardly inclining releasing face, an actuator, and an operator formed with a first beam, the first beam being movable, together with the actuator, from a latched position to a released position along the releasing face of the releasing portion to expel the latching tab outwardly to release the latching protrusion from the latching hole of the receptacle.

2. The plug connector as claimed in claim 1, wherein said latching protrusion has a forwardly downwardly extending latching face, said releasing face of the releasing portion extending continuously from the latching face of the latching protrusion.

3. The plug connector as claimed in claim 1, wherein said operator includes a second beam and two third beams, and an opening surrounded by the first through third beams, said latching protrusion being plunged in the opening in the latched position.

4. The plug connector as claimed in claim 1, wherein said first beam of the operator is formed with an obliquely extending first face cooperating with the releasing face of the releasing portion.

5. The plug connector as claimed in claim 1, wherein said housing has a primary face, said latching protrusion and the releasing portion being formed on the primary face.

6. The plug connector as claimed in claim 5, wherein said housing includes a receiving space defined in the primary face, and said releasing mechanism comprises a deformable portion between the operator and the actuator and received in the receiving space.

7. The plug connector as claimed in claim 6, wherein said receiving space includes a longitudinally extending securing recess and a transversely extending receiving recess, and said deformable portion has a body portion secured in the securing recess and a pair of resilient portions each being substantially U-shaped and compressible in the receiving recess.

8. The plug connector as claimed in claim 7, wherein said housing has a pair of supporting portions formed on the primary face for being abutted against by the pair of resilient portions, and an indentation between the pair of supporting portions, said deformable portion having a stepped portion connecting with the operator and situated in the indentation.

9. The plug connector as claimed in claim 5, further including a pair of screws and a shielding plate attached to the primary face of the housing, said shielding plate defining a pair of through holes, said housing defining a pair of inserting holes, each of said screws inserting through the though hole and the inserting hole to secure the shielding plate onto the housing.

10. A connector assembly comprising:
a receptacle having a latching tab defining a latching hole; and
a plug connector including:
a housing having a latching protrusion for latching with the latching hole of the receptacle; and
a releasing mechanism comprising a releasing portion formed in front of the latching protrusion and having a forwardly downwardly inclining releasing face, an actuator, and an operator formed with a first beam, the first beam being movable, together with the actuator, from a latched position to a released position along the releasing face of the releasing portion to expel the latching tab outwardly to release the latching protrusion from the latching hole of the receptacle.

11. The connector assembly as claimed in claim 10, wherein said latching protrusion has a forwardly downwardly extending latching face, said releasing face of the releasing portion extending continuously from the latching face of the latching protrusion.

12. The connector assembly as claimed in claim 10, wherein said operator is formed with a second beam and two third beams, and an opening surrounded by the first through third beams, said latching protrusion being plunged in the opening in the latched position.

13. The connector assembly as claimed in claim 10, wherein said housing includes a receiving recess, said releasing mechanism comprising a deformable portion between the operator and the actuator, said deformable portion having a pair of resilient portions each substantially formed into a U-shape and compressible in the receiving recess.

14. An electrical connector assembly comprising:
a plug defining a housing having opposite top and bottom faces in a vertical direction with a latching protrusion downwardly formed on the bottom face for latchable engagement within a latching hole in a up and down deflectable locking tab of a receptacle cage;
a cable extending rearwardly from a rear side of the housing; and
a one-piece releasing mechanism including a pulling member located around the top face and an operator around the bottom face in a front-to-back direction perpendicular to the vertical direction, and a through hole formed between the pulling member and the operator with the cable extending through said through hole so as to have said operator move rearwardly synchronically when the pulling member is manually grasped to move the whole releasing mechanism rearwardly; wherein
the housing defines a downward gradient structure along which the operator moves, when said operator is moved rearwardly, for downwardly deflecting the locking tab and unlatching the latching protrusion from the latching hole of the locking tab so as to allow the whole plug to be withdrawn from the receptacle cage.

15. The electrical connector assembly as claimed in claim 14, wherein said downward gradient structure is formed on the latching protrusion.

16. The electrical connector assembly as claimed in claim 15, wherein operator defines an opening with a transverse beam aside said opening while commonly aligned with the latching hole in the front-to-back direction under condition that during operation, the opening receives the latching protrusion and the transverse beam abuts against the latching protrusion for resulting in downward deflection of the locking tab.

17. The electrical connector assembly as claimed in claim 14, wherein said releasing mechanism further includes a resilient portion to urge the whole releasing mechanism back to an original front position after the whole releasing mechanism is moved rearwardly to a final rear position.

18. The electrical connector assembly as claimed in claim 17, wherein said resilient portion is proximal to the latching protrusion.

19. The electrical connector assembly as claimed in claim 14, further including a shielding plate attached to the bottom face of the housing and cooperating with the housing to sandwich the releasing mechanism therebetween in the vertical direction.
